(19) United States
(12) Patent Application Publication
(10) Pub. No.: US 2009/0172425 A1
(43) Pub. Date: Jul. 2, 2009

(54) Digitally controlled dynamic power management unit for uninterruptible power supply

(75) Inventors: Joseph A. Cetin, San Diego, CA (US); Patrick J. Sullivan, San Diego, CA (US)

Correspondence Address: FSP LLC, P.O. BOX 890, VANCOUVER, WA, 98666, US

(73) Assignee: Simtek, Colorado Springs, CO (US)

(21) Appl. No.: 12/006,229

(22) Filed: Dec. 31, 2007

(51) Int. Cl. G06F 1/26

(52) U.S. Cl. 713/300

(57) ABSTRACT

A memory system power management process includes providing a first level of power to operate a memory system while a primary power source is enabled, detecting an interruption of the primary power source, increasing a frequency of an oscillator driving a charge pump of a power converter providing the first level of power, and beginning a memory operation that increases a load on the power converter.

### TECHNICAL FIELD

The present disclosure relates to power supplies.

### BACKGROUND

In some power supply applications, a charge pump may be used to convert DC power of a first voltage and power level to different output voltage/current requirements. The charge pump may employ one or more flying capacitors switching at a certain switching frequency. One method of increasing the charge pump output current is to increase the switching frequency of the charge pump. Operating the charge pump always at a high switching frequency is not ideal for overall power efficiency, however.

Conventional charge pump designs operate at a fix frequency of operation until after the charge pump detects the voltage drop at its load supply. Prior methods may sense load current change in a feedback loop, and/or may monitor output voltage level and respond when the output voltage drops below a preset value. Hence, conventional methods do not employ a-priori knowledge of when the load requirement is going to change and only respond when the change has already occurred. Due to the slow response time to this higher output current requirement, the output voltage may drop substantially before the charge pump can respond to the greater load demand. Depending on how severely the output current requirements increase, the output voltage may drop below required levels. Additionally, conventional charge pumps may be slow to detect the increased current demands of the load, and must work highly rigorous to bring the output voltage to required level, causing increased ripple (transient effects) at the output.

### BRIEF DESCRIPTION OF THE DRAWINGS

In the drawings, the same reference numbers and acronyms identify elements or acts with the same or similar functionality for ease of understanding and convenience. To easily identify the discussion of any particular element or act, the most significant digit or digits in a reference number refer to the figure number in which that element is first introduced.

FIG. 1 is a block diagram of an embodiment of a power control system.

FIG. 2 is a block diagram of an embodiment of a power controller.

FIG. 3 is an illustration of an embodiment of a charge pump.

FIG. 4 is a flow chart of an embodiment of a power control process.

FIG. 5 is a flow chart of an embodiment of a power control process for backup memory operation.

### DETAILED DESCRIPTION

References to “one embodiment” or “an embodiment” do not necessarily refer to the same embodiment, although they may.

Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number also include the plural or singular number respectively. Additionally, the words “herein,” “above,” “below” and words of similar import, when used in this application, refer to this application as a whole and not to any particular portions of this application. When the claims use the word “or” in reference to a list of two or more items, that word covers all of the following interpretations of the word: any of the items in the list, all of the items in the list and any combination of the items in the list.

“Logic” refers to signals and/or information that may be applied to influence the operation of a device. Software, hardware, and firmware are examples of logic. Hardware logic may be embodied in circuits. In general, logic may comprise combinations of software, hardware, and/or firmware.

Those skilled in the art will appreciate that logic may be distributed throughout one or more devices, and/or may be comprised of combinations of instructions in memory, processing capability, circuits, and so on. Therefore, in the interest of clarity and correctness logic may not always be distinctly illustrated in drawings of devices and systems, although it is inherently present therein.

As described herein, a power management system for a device or subsystem thereof (such as a memory subsystem) may include a power converter. The operating frequency of the power converter may be increased when a loss of primary power to or within the device or the device subsystem is detected. The power converter may operate using a charge pump having at least one flying capacitor driven by an oscillator. The frequency of this oscillator may be increased in anticipation of, but prior to, an increased load on the power converter.

As an example of an application of these principles, a memory system including volatile and nonvolatile memory circuits may draw power from a power controller. Operations on the memory circuits may be directed, at least in part, by a memory controller. The power controller may to provide power to at least the volatile and nonvolatile memory circuits, and may also provide power to the memory controller and other components of the memory system. The memory system may include logic to cause an increase in the operating frequency of a power converter of the power controller prior to an imminent higher power operation on one or more of the volatile and nonvolatile memory circuits. For example, upon interruption of primary power to the memory system (for example, either due to a deliberate power down or inadvertent power failure), the frequency of an oscillator driving the power converter (which may include one or more flying capacitors) may be increased, thus increasing the power load capacity of the power converter, in anticipation of a higher-power memory operation, such as a backup of volatile memory to nonvolatile memory. The system may be powered by a backup power source (such as one or more capacitors or batteries) during the backup operation.

A device may be constructed comprising a power control in accordance with the embodiments described herein. The device will typically comprise at least one processor, for example a general purpose microprocessor, an embedded special-purpose processor, a digital signal processor, and so on. The processor and/or other components of the device may rely upon the power control for power, and may at various times make a wide range of power demands, depending on the circumstances. The power control may respond to the varied power demands of the device components by utilizing embodiments of the structures and techniques described herein.

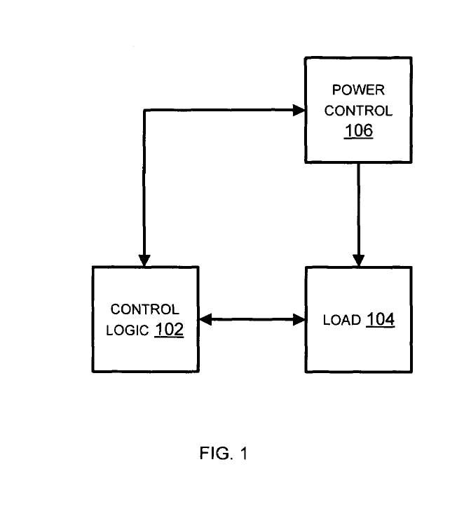

FIG. 1 is a (simplified) block diagram of an embodiment of a power control system. The system may include control logic 102 (e.g. a memory controller), a power controller 106, and a load 104 (such as one or more large-scale memory arrays, including volatile and nonvolatile memory circuits). The system may operate according to the principles described herein, in order to provide higher-levels of power when needed by the load, without incurring all the overhead that providing such higher power involves during periods when lower power supply is sufficient.

In certain applications there may be a high power demand at times. At other times, the demand for power may be lower. If the power control 106 is designed to at all times meet the higher demand scenario, it may be over-designed for its most common mode of lower power operation. In higher-power modes, the efficiency of the power control may be significantly reduced over its efficiency in lower-power modes. When the efficiency is reduced, the life (i.e. time before power is drained) of any batteries or capacitors supplying the power control 106 may also be reduced. Hence, a more expensive source of backup power for the application may be required. Also, in order to provide high current output, the power control may require larger capacitors and other electrical elements if designed for to always deliver the higher-power demands. When capacitors are made large, the devices (switches) required to operate the capacitors must also typically be made large in order to handle the increase output power of the capacitors. When the switches are made large, the circuitry that drives these switches must also be made large, and so on. The larger circuitry requires larger power in order to operate properly, again increasing the power drained from any supply battery(s) or capacitor(s).

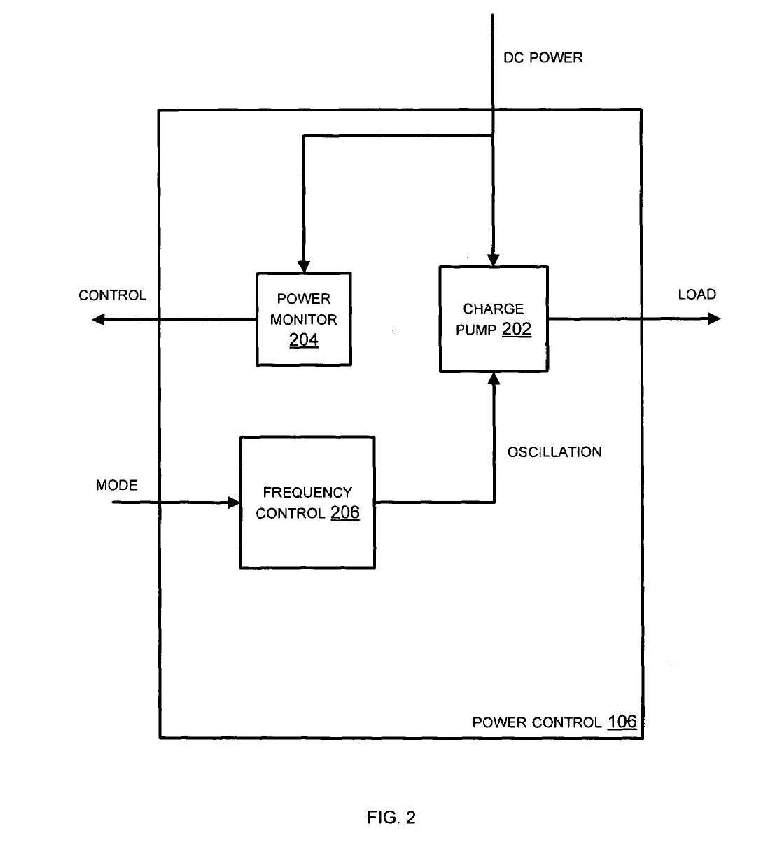

FIG. 2 is a block diagram of an embodiment of a power controller. The power controller 106 may include a power monitor 204 to detect an interruption of a primary power source to whatever device or subsystem includes the power controller 106. A charge pump 202 may supply power to a load. The power requirements of the load may vary substantially, depending on the circumstances. For example, operation of the load while primary power is enabled may involve a relatively low first power level. However, upon interruption of primary power, operation of the load may increase, in some cases dramatically, due to certain operations that are initiated upon detecting the loss of primary power. For example, if the load is one or more large-scale memory arrays including volatile and nonvolatile memory circuits, the loss of primary power may cause a memory controller (e.g. logic 102) to initiate a large-scale backup of the volatile arrays to the nonvolatile arrays, drawing substantially higher power than is drawn at the lower power level.

In anticipation of, but prior to, initiation of the higher-power operation of the load, a frequency control 206 may change (i.e. increase) the frequency of an oscillating signal to the charge pump 202, so that when the increase in the power draw by the load occurs, the power control 106 is prepared to deliver the extra power.

As an example of how such a power control 106 may operate, a source of DC power to the power monitor 204 and charge pump 202 may suddenly experience a loss or primary power, and may switch to a backup power source. The power monitor 204 may detect this interruption of primary power, and may provide an indication as such to a memory controller (e.g. logic 102). The memory controller may, prior to initiating a backup of volatile memory circuits to nonvolatile memory circuits (to preserve volatile data nonwithstanding the interruption of primary power), signal the frequency control 206 (directly or indirectly) with a mode or other indication to increase the oscillation frequency provided to the charge pump 202. Pumped at a higher frequency, the charge pump 202 may now be better prepared, prior to an actual increase in the load requirements, to supply a higher power level to the load. The power control 106 may thus supply a higher level of power with lower transient effects (such as a drop on the load voltage level or sudden spike in the output current draw by the load) than it would have otherwise.

When utilized in a memory subsystem of a digital device, the load may be comprised mainly of digital data processing elements and memory devices. The digital data processing elements (which may operate the memory devices) may have load current demands that vary from a couple of milliamps (mA) to the hundreds of mA over time. Hence, achieving high power efficiency over wide load ranges is important, especially when operating on backup power sources such as batteries or capacitors, because sensing the total stored energy of such devices may be difficult and imprecise. The power control 106 may have an increased power efficiency over the wide load range by utilizing a priori knowledge of the digital data processing element's current demands.

In one implementation, the controller 102 may notify the power control 106 that an increase of the load current is imminent. This enables the power control 106 to be ready for this extra load requirements by changing its operating mode to a high current output mode right before the extra current demand is required. For overall power efficiency the power control 106 may only remain in the high current mode while the actual high current is needed, and return to low current mode when the demand disappears.

The power control 106 may utilize a DC/DC charge pump to adjust an output voltage level and convert battery (or capacitor-supplied) power to a DC current. The DC/DC charge pump may utilize one or more flying capacitors switching at a certain switching frequency. One method of increasing the charge pump output current is to increase the switching frequency applied to these flying capacitors. Operating the charge pump always at a high switching frequency is not ideal for overall power efficiency. The control logic 102 may notify the power control 106 that an increase in current will be required, and then the power control 106 may increase the switching frequency of the flying capacitors to efficiently prepare for the increased load demand. When the output current requirement is again reduced, the switching frequency is also reduced to maintain operating efficiency.

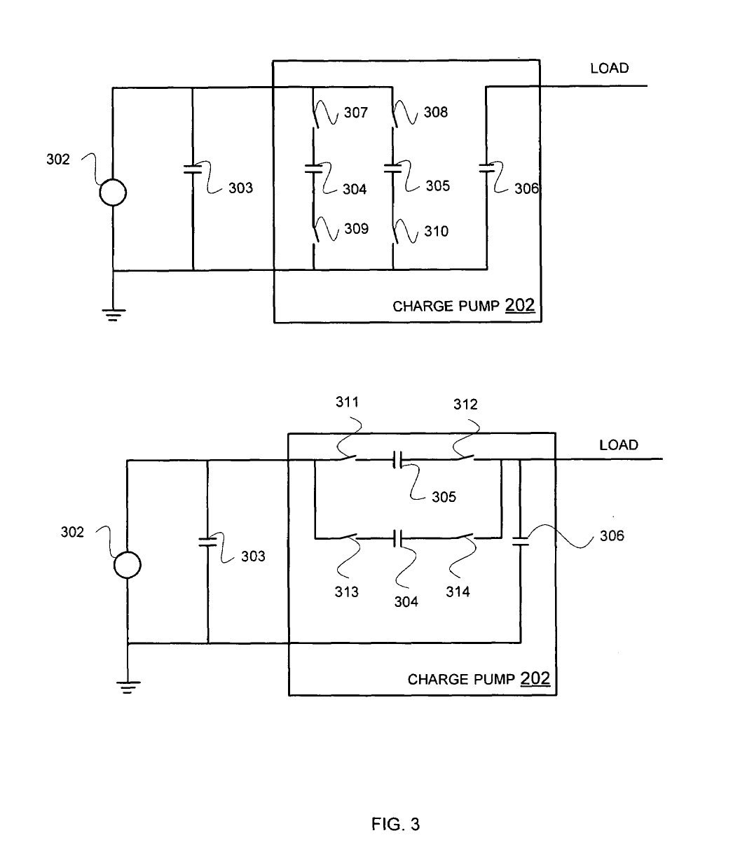

FIG. 3 is an illustration of an embodiment of a charge pump. The charge pump 202 is supplied by a primary power source 302 and a backup power source (e.g. capacitor 303). A load is driven from power supplied by an output capacitor 306. During a charging phase (top), the flying capacitors 304, 305 (there may of course be more or fewer, depending upon the implementation) are switched in parallel with the primary power source 302 and backup power source 303, building charge on the capacitors 304, 305 to enable them to deliver an output voltage and current requirement of the load. The higher a frequency provided to the flying switches (e.g. CMOS switching transistors) 307-310, the greater charge may build on the capacitors 304-305 during the charging phase. During the charging phase, the load is driven by the output capacitor 306 (again, there may be more than one). During a discharge (e.g. supply) phase (bottom), the flying capacitors 304-305 are switched in series with the load (via switches 311-314), delivering an output voltage and current requirement of the load.

The following description applies to one embodiment of a power control 106 utilizing a charge pump 202 similar, for example, to the embodiment illustrated in FIG. 3. The charge pump 202 may receive an input from a power source (e.g. supply elements 302-303) and generate a regulated output voltage (e.g. voltage of element 306) that powers the control logic 102 and load 104 (e.g. SDRAM memory circuits and NAND FLASH elements). The output voltage is maintained within a controlled range even when the load current requirements vary over a significant range. The charge pump 202 may utilize flying capacitors 304-305 in order to transfer energy from the input power sources to the load. An driving frequency (e.g. clock source) may be provided to the charge pump 202. The faster the clock, the faster the energy transfer to the capacitors 304-305 and hence the load. Also, the faster the clock, the greater power demands of the driver circuit that operates the flying capacitors. The capacitor 306 serves as a temporary power source to the load 104. The frequency of the clock provided to the charge pump 202 may vary depending on the anticipated load requirements, and may be selected from multiple clock signals that are generated. In other embodiments, a single clock signal having a variable frequency may be generated, depending on the anticipated load. At higher clock frequencies the charge pump 202 may transfer energy at a higher rate. Similarly, if the load demand is lower, the clock may operate at lower frequency to enable the charge pump 202 to operate more efficiently.

The control logic 102 may provide a “done” signal to the power control 106 to indicate the power demand on the charge pump 202 will be low or not needed at all. Hence, the charge pump 202 may be switched into a low power or even a sleep mode.

In some embodiments, a clock generator provides clock signals to the power control 106 and control logic 102. The clock generator may receive an reference clock from a source such as crystal oscillator which is connected to quartz crystal pins and to various other elements such as capacitors. The reference clock frequency is at the quartz crystal oscillation frequency and may serve as the reference clock for the clock generator. The clock generator may generate two or more output clock (e.g. Fast Clock and Slow Clock) for different modes of operation. One of these reference clocks may be applied to the charge pump 202, depending on the anticipated power demands. The Fast Clock and Slow Clock may have any reasonable frequency that the charge pump 202 is designed to handle. For example, frequencies of 2 MHz and 4 MHz for the Slow Clock and Fast Clock may be used in certain memory system applications.

The power monitor 204 may have several functions, depending upon the application. It may monitor the supply voltage, determine when backup supply 303 is fully charged and available, and determine when primary power 302 is interrupted or impaired. The power monitor 204 may, in some applications, monitor the charge pump 202 output (e.g. voltage at 306) in order to determine if the overall system steady state operation is achieved and that the overall system may operate even if the primary power source is unavailable. While performing such monitoring activities, the power monitor 204 may communicate multiple signals to the control logic 102. For example, a signal “Power Good” may be generated when the charge pump 202 output (e.g. 306) has achieved a steady state operation. A signal “Fail Detect” may be issued when primary power is interrupted or impaired. A signal “Reserve Full” may be issued when a sufficient backup supply power level is achieved.

The frequency control 206 may in some applications include clock select logic. The clock select logic may determine the appropriate clock to meet anticipated energy transfer rates of the charge pump 202 to the load. In some applications the clock select logic may receive two or more clock signals (e.g. Fast Clock and Slow Clock) from the clock generator. It may also receive from the control logic 102 a signal indicating an impending high-power operation, such as “Save Began”. The “Save Began” signal may be an indication that the control logic 102 will enable SDRAM arrays to start consuming large amount of current to implement backup operations from volatile to nonvolatile memory circuits. When the control logic 102 communicates “Save Began”, the clock select logic identifies which clock frequency should be output to the charge pump 202.

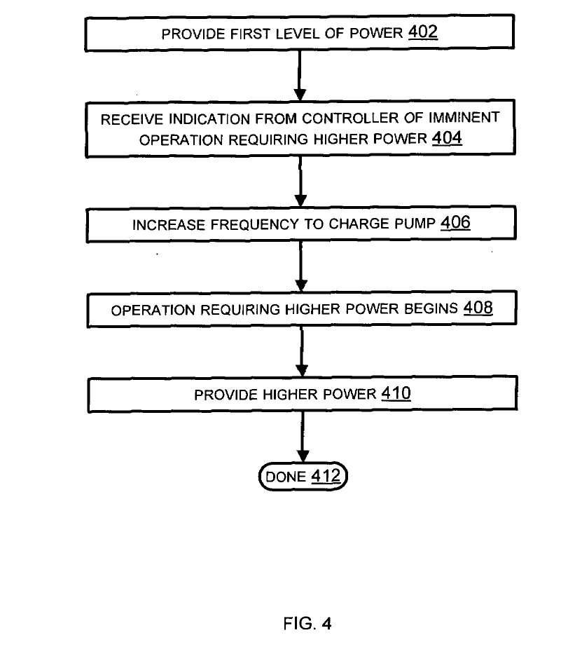

FIG. 4 is a flow chart of an embodiment of a power control process. A first level of power is provided (402) until some indication of an event that may lead to an increased demand for power (404), above the first level requirements. Of course, in some implementations the indication could also be of an impending event that will lead to lower demand, in which case the supply frequency to the charge pump may be dropped in anticipation of lower subsequent demand.

In the illustrated situation, the frequency of a signal driving a charge pump is increased (406), the higher-power operation begins (408) and the higher power is provided (410) with lower latency and decreased transient effects than what might take place otherwise.

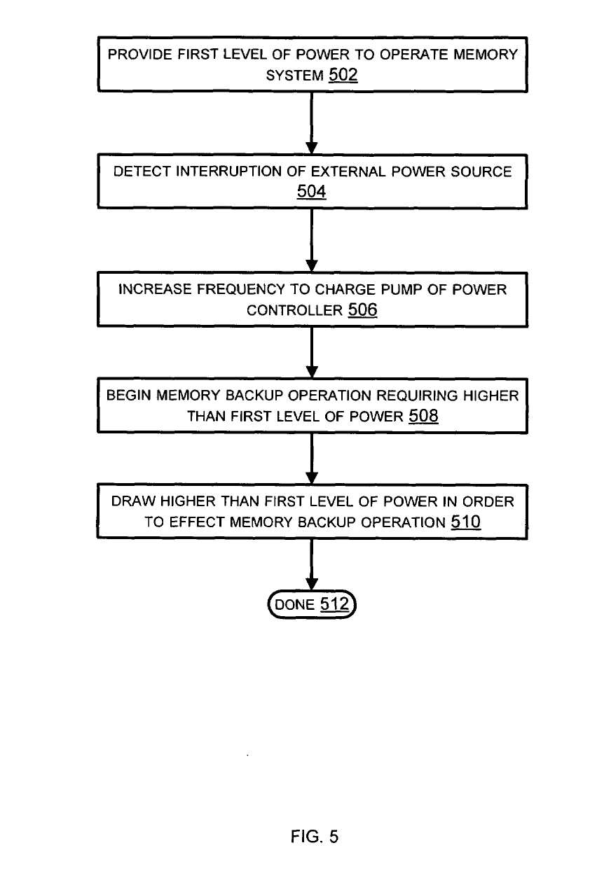

FIG. 5 is a flow chart of an embodiment of a power control process for backup memory operation. The process may be applied to provide a first level of power to operate a memory system (502), for example while a primary power source is enabled. An interruption of the primary power source may be detected (504), resulting in an increase in the frequency of an oscillator driving a charge pump of a power controller (e.g. a power converter) providing the first level of power (506). A memory backup operation may then be initiated that increases a load on the power converter (508-510). An example of a backup operation is the backup of volatile memory to nonvolatile memory while operating on a backup power source.

Those having skill in the art will appreciate that there are various vehicles by which processes and/or systems described herein can be effected (e.g., hardware, software, and/or firmware), and that the preferred vehicle will vary with the context in which the processes are deployed. For example, if an implementer determines that speed and accuracy are paramount, the implementer may opt for a hardware and/or firmware vehicle; alternatively, if flexibility is paramount, the implementer may opt for a solely software implementation; or, yet again alternatively, the implementer may opt for some combination of hardware, software, and/or firmware. Hence, there are several possible vehicles by which the processes described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations may involve optically-oriented hardware, software, and or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood as notorious by those within the art that each function and/or operation within such block diagrams, flowcharts, or examples can be implemented, individually and/or collectively, by a wide range of hardware, software, firmware, or virtually any combination thereof. Several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in standard integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and/or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies equally regardless of the particular type of signal bearing media used to actually carry out the distribution. Examples of a signal bearing media include, but are not limited to, the following: recordable type media such as floppy disks, hard disk drives, CD ROMs, digital tape, and computer memory; and transmission type media such as digital and analog communication links using TDM or IP based communication links (e.g., packet links).

In a general sense, those skilled in the art will recognize that the various aspects described herein which can be implemented, individually and/or collectively, by a wide range of hardware, software, firmware, or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of random access memory), and/or electrical circuitry forming a communications device (e.g., a modem, communications switch, or optical-electrical equipment).

Those skilled in the art will recognize that it is common within the art to describe devices and/or processes in the fashion set forth herein, and thereafter use standard engineering practices to integrate such described devices and/or processes into larger systems. That is, at least a portion of the devices and/or processes described herein can be integrated into a network processing system via a reasonable amount of experimentation.

The foregoing described aspects depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality.

What is claimed is:

1. A power management system comprising:
a power converter; and
logic to increase an operating frequency of the power converter when a loss of primary power to a system comprising the power converter is detected.

2. The power management system of claim 1, wherein the power converter further comprises:
a charge pump comprising at least one flying capacitor driven by an oscillator.

3. A memory system comprising:
volatile and nonvolatile memory circuits;
a memory controller;
a power controller to provide power to at least the volatile and nonvolatile memory circuits; and
logic to cause an increase in the operating frequency of a power converter of the power controller prior to an imminent higher power operation on one or more of the volatile and nonvolatile memory circuits.

4. The memory system of claim 3, wherein the power converter further comprises:
a charge pump comprising at least one flying capacitor driven by an oscillator.

5. The memory system of claim 3, wherein the logic to cause an increase in the operating frequency of a power converter of the power controller prior to an imminent higher power operation further comprises:
logic to cause an increase in the operating frequency of a power converter of the power controller prior to an imminent backup of the volatile memory circuits to the nonvolatile memory circuits.

6. The memory system of claim 5, wherein the power converter further comprises:
a charge pump comprising at least one flying capacitor driven by an oscillator.

7. The memory system of claim 3, wherein the logic to cause an increase in the operating frequency of a power converter of the power controller prior to an imminent higher power operation further comprises:
logic to cause an increase in the operating frequency of at least one flying capacitor of the power controller prior to an imminent higher power operation.

8. The memory system of claim 3, further comprising:
primary and secondary power sources coupled to the power controller; and
logic to detect a loss of the primary power and to consequently operate the power controller using the secondary power, and to cause an increase in the operating frequency of a power converter of the power controller prior to an imminent higher power operation on one or more of the volatile and nonvolatile memory circuits as a result of the loss of primary power.

9. The memory system of claim 8, wherein the power converter further comprises:
a charge pump comprising at least one flying capacitor driven by an oscillator.

10. A memory system power management process comprising:
providing a first level of power to operate a memory system while a primary power source is enabled;
detecting an interruption of the primary power source;
increasing a frequency of an oscillator driving a charge pump of a power converter providing the first level of power; and
beginning a memory operation that increases a load on the power converter.

11. The memory system power management process of claim 10, wherein the beginning a memory operation that increases a load on the power converter further comprises:
beginning a backup of volatile memory to nonvolatile memory.

12. The memory system power management process of claim 10, further comprising:
operating the memory system using a backup power source upon interruption of the primary power source.

13. A power management system, comprising:
a power converter; and
logic to cause an increase in the operating frequency of the power converter prior to an imminent higher power operation involving a load supplied by the power converter.

14. The system of claim 13, wherein the power converter further comprises:
a charge pump comprising at least one flying capacitor driven by an oscillator.

15. The system of claim 13, wherein the logic to cause an increase in the operating frequency of a power converter prior to an imminent higher power operation further comprises:
logic to cause an increase in the operating frequency of at least one flying capacitor of the power converter prior to an imminent higher power operation.
